(19) United States
(12) Patent Application Publication
(10) Pub. No.: US 2018/0180420 A1
(43) Pub. Date: Jun. 28, 2018

(54) Method and System for Improving Inertial Measurement Unit Sensor Signals

(71) Applicant: Michael KORENBERG, Battersea (CA)

(72) Inventor: Michael Korenberg, Battersea (CA)

(21) Appl. No.: 15/501,004

(22) PCT Filed: Aug. 4, 2015
(86) PCT No.: PCT/CA2015/000522

§ 371 Date: Feb. 1, 2017

(51) Int. Cl. G01C 21/16; G06N 3/08

(52) U.S. Cl. CPC G01C 21/165; B64C 39/024; G06N 3/08

(57) ABSTRACT

The invention relates generally to production and handling of navigational data. In one aspect, a method is provided to increase the predictive ability over novel data of models on a computer processor. The method comprises the steps of using training values of system input/desired system output data to obtain a plurality of models corresponding to different parameter settings, measuring the ability of the obtained models to predict desired output values not used to obtain the models, choosing a subset of the models by preferentially selecting according to measured predictive ability, and averaging the outputs of the selected models over the novel data.

### TECHNICAL FIELD

The claimed invention generally relates to navigation and to inertial measurement units (IMUs) and to methods and systems for providing positioning and navigation information and location. More specifically, the claimed invention relates to methods and systems that utilize microelectromechanical systems (MEMS) or other IMUs data to provide positioning solutions.

### BACKGROUND ART

Low-cost MEMS-based inertial measurement units, such as IMU CC-300 Crossbow) and similar devices, are becoming increasingly popular as part of navigation solutions for vehicles and are also in mobile devices including smart phones, and are typically integrated with the global positioning system (GPS). These MEMS-based devices are also used in indoor positioning systems in GPS-denied environments. However, MEMS-based inertial sensors have significant errors that can negatively impact the accuracy of the overall navigation solution. The challenge is to reduce noise contamination and improve the accuracy of MEMS-based systems to approach that of much more expensive tactical-grade and navigation-grade IMUs.

A variety of techniques such as Gauss-Markov modeling, Wavelet de-noising, and Fast Orthogonal Search have been used in an effort to remove MEMS-based inertial sensor errors. Unfortunately, there is still a lack of rapid techniques to enhance MEMS-based accelerometer and gyroscope signals and thus provide a low-cost MEMS-based device with accuracy approaching that of much higher-cost tactical- and navigation-grade IMUs. Therefore, it would be desirable to have a system and method whereby MEMS-based measurements can be taken and transformed to approach the accuracy of much higher cost devices. Furthermore, it would be desirable for such a system and method to be capable of transforming the MEMS-based measurements in real-time.

### THE DRAWINGS

FIG. 1A illustrates a parallel cascade model used in an embodiment of the invention.

FIG. 1B is a flow chart outlining the steps of one embodiment of a parallel cascade identification (PCI) process.

FIG. 2A illustrates a portion of a MEMS-based acceleration signal (y-component), the training input used with the signal of FIG. 2B in illustrating one embodiment of the claimed invention.

FIG. 2B illustrates a corresponding portion of a desired output signal for the acceleration y-component, which is used with the signal of FIG. 2A to illustrate the training input/output data employed to identify a parallel cascade model in an embodiment of the claimed invention.

FIG. 2C illustrates the model output when the training input of FIG. 2A is the input to the identified parallel cascade model.

FIG. 3A illustrates a portion of a MEMS-based acceleration signal (y-component), recorded starting about 43 minutes after the end of the training data in FIG. 2.

FIG. 3B illustrates the improved acceleration signal (y-component) resulting from feeding the signal of FIG. 3A through the model identified from the training data of FIG. 2.

FIG. 3C illustrates the actual tactical-grade acceleration signal (y-component), with which FIG. 3B should be compared.

FIG. 4A illustrates a portion of a MEMS-based acceleration signal (y-component), recorded near the end of a different trajectory one day after the gathering of the training data in FIG. 2A,B.

FIG. 4B illustrates the improved acceleration signal (y-component) resulting from feeding the signal of FIG. 4A through the model identified from the training data of FIG. 2A,B.

FIG. 4C illustrates the actual tactical-grade acceleration signal (y-component), with which FIG. 4B should be compared.

FIG. 5A illustrates a portion of a MEMS-based gyroscope angular rotation signal (z-component), the training input used with the signal of FIG. 5B in illustrating one embodiment of the claimed invention.

FIG. 5B illustrates a corresponding portion of a desired output signal for the gyroscope angular rotation signal (z-component), which is used with the signal of FIG. 5A to illustrate the training input/output data employed to identify a parallel cascade model in an embodiment of the claimed invention.

FIG. 5C illustrates a portion of a MEMS-based gyroscope angular rotation signal (z-component), recorded starting about 43 minutes after the end of the training data in FIGS. 5A,B.

FIG. 5D illustrates the improved gyroscope angular rotation signal (z-component) resulting from feeding the signal of FIG. 5C through the model identified from the training data of FIGS. 5A,B.

FIG. 5E illustrates the actual tactical-grade gyroscope angular rotation signal (z-component), with which FIG. 5D should be compared.

FIG. 6A illustrates a portion of a MEMS-based gyroscope angular rotation signal (z-component), recorded near the end of a different trajectory one day after the gathering of the training data in FIGS. 5A,B.

FIG. 6B illustrates the improved gyroscope angular rotation signal (z-component) resulting from feeding the signal of FIG. 6A through the model identified from the training data of FIGS. 5A,B.

FIG. 6C illustrates the actual tactical-grade gyroscope angular rotation signal (z-component), with which FIG. 6B should be compared.

FIG. 7A shows the extended trajectory, a portion of which corresponds to FIGS. 4A, 6A, as indicated by a high-end tactical grade IMU tightly-coupled with GPS integration.

FIG. 7B shows the corresponding trajectory as indicated when the tactical grade IMU signals are replaced by model-improved MEMS accelerometer and gyroscope signals, according to an embodiment of the claimed invention, again tightly-coupled with GPS integration.

FIG. 7C shows the corresponding trajectory as indicated when the tactical grade IMU signals are replaced by raw signals from the MEMS accelerometers and gyroscopes, again tightly-coupled with GPS integration.

### DETAILED DESCRIPTION OF THE INVENTION

Low-cost MEMS-based inertial measurement units (IMUs) contain accelerometers, which measure acceleration, and gyroscopes, which measure angular rotation, but MEMS-based signals are notoriously noisy. The present invention has been designed to transform the signals from MEMS-based instruments to approach the accuracy of signals from much higher cost tactical-grade and navigation-grade instruments, and also to improve the accuracy of other IMUs. The data derived from the MEMS IMUs are processed using nonlinear system identification and time series analysis techniques such as parallel cascade identification (PCI) and fast orthogonal search (FOS) algorithms. Both PCI and FOS algorithms are known in the art. For example, for PCI, see M. J. Korenberg, 1991, “Parallel Cascade Identification and Kernel Estimation for Nonlinear Systems”, Annals of Biomedical Engineering, Vol. 19, pp. 429-455.

For FOS, see e.g. M. J. Korenberg, 1989, “A Robust Orthogonal Algorithm for System Identification and Time-Series Analysis”, Biological Cybernetics, Vol. 60, pp. 267-276. (A copy of this paper is appended to this provisional patent application for reference). When FOS is used for spectral analysis, it does not assume periodicity and provides improved spectral resolution over the discrete Fourier transform. FOS can also be useful in identifying systems of unknown structure.

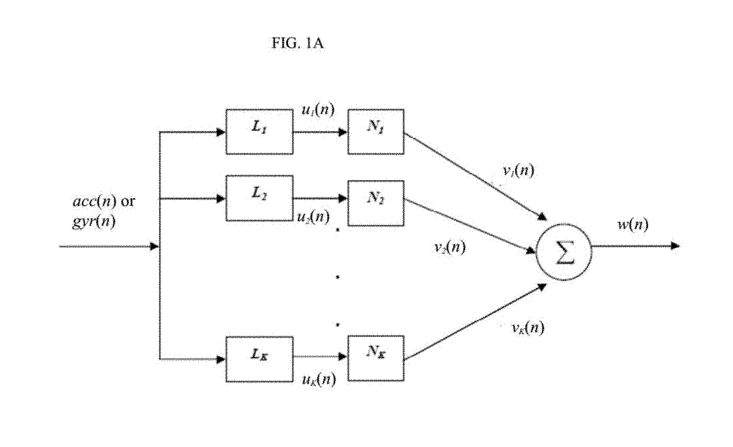

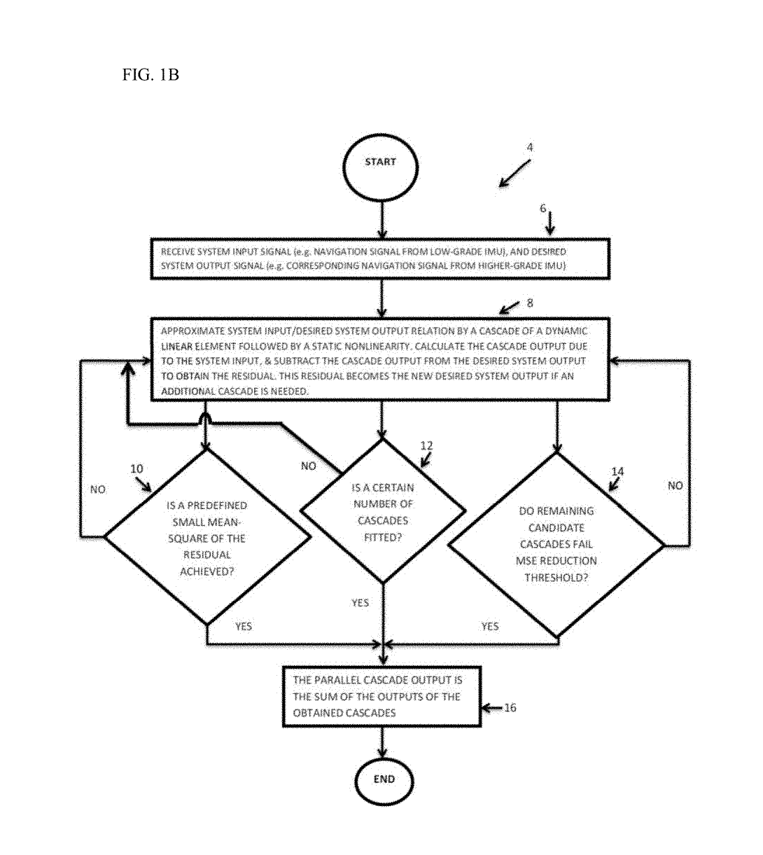

FIG. 1A illustrates a parallel cascade model used in an embodiment of the invention, where the independent variable n denotes discrete time. Here the same model input acc(n) (denoting one of acceleration-x, -y, or -z component signals) or alternatively gyr(n) (denoting one of gyroscope-x, -y, or -z component signals) is fed to K parallel cascades, where K≥1. Each cascade comprises a series connection of a dynamic linear element L and a static nonlinear element N. In the first cascade pathway, for example, the model input is fed to the dynamic linear element L₁ and the resulting output u₁ of L₁ is then the input to static nonlinear element N₁ whose output v₁. In one embodiment of the invention, the output u₁ of L₁ is obtained from the model input using a well-known convolution sum, as discussed in Korenberg 1991 (cited above). Other embodiments can use an auto-regressive moving average (ARMA) or other model to represent some or all of the linear elements L. In one embodiment of the invention, the output v₁ of the first cascade is obtained by a polynomial function of the signal u₁. The signals and the outputs of the other cascades are numbered analogously.

A key advantage of the parallel cascade model is that the memory resides in the dynamic linear elements, while the nonlinearities are confined to static elements. This results in a very rapid scheme for finding the parallel cascade model to approximate a system, given only the system input acc(n) or gyr(n) and the resulting system output (Korenberg, 1991, cited above). For example, the cascades can be identified one at a time.

FIG. 1B is a flow chart 4 outlining the steps of one embodiment of the parallel cascade identification (PCI) process which may be used to produce a model according to some of the embodiments disclosed herein. To begin the process, at step 6 a system input signal and a desired system output signal are received. In the present invention, the system input was typically a navigation signal from a MEMS device or other lower-grade device, and the desired system output was the corresponding signal of a higher-grade device that resulted in a more accurate navigation solution. The signals were recorded simultaneously on the same trajectory.

Then, during step 8, a first cascade is identified to approximate the given system. The first linear system L₁ can be represented by a discrete-time unit impulse response, which can be defined using a first-order cross-correlation of the input with the output, or a slice of a second- or higher-order cross-correlation with weighted discrete impulse functions added or subtracted at diagonal values (Korenberg 1991, cited above). The choice of slice can be made randomly, or using a deterministic sequence, while testing the benefit of adding a given candidate cascade as described below and in Korenberg (1991, cited above). Once the impulse response has been obtained, the convolution sum can be used to calculate the output u₁ of L₁. Next a polynomial having input u₁ can be best-fit, in the least-squares sense, to the system output.

Once the first cascade is identified, its output is calculated, and then subtracted from the system output, to yield the first residual. If desired, a second cascade can then be identified analogously, with the first residual taking the place of the system output in step 8, and so on. Often only a few cascades were required in the model developed to enable the model output to approximate sufficiently the desired system output.

At step 10, 12 and 14, the PCI process may be stopped when at least one of the following predefined conditions are met. Firstly, an acceptably small mean-square error (MSE) has been achieved, i.e. the mean-square of the residual is sufficiently small. Secondly, the search may also stop when a certain number of cascades have been fitted. Thirdly, the search may stop when none of the remaining candidate cascades can yield the benefit of a sufficient MSE reduction value. As a non-limiting example, one criterion in such an embodiment would be representative of not having any candidate cascades that would yield an MSE reduction value greater than would be expected if the residual were white Gaussian noise. This criterion helps to avoid adding cascades that are merely fitting noise.

Recall that the signals and the outputs of the other cascades are numbered analogously, and obtained analogously. In step 16, the parallel cascade output w is the sum of the K cascade outputs

$$w = {\sum }_{i = 1}^{K} {v}_{i}$$

where w and v₁, . . . , v_{K} have the meaning shown in FIG. 1A.

An advantage of the structure in FIG. 1A is it enables the identified parallel cascade model to generate its output very rapidly and, for the present applications, the output generation can be carried out in real-time on modern digital signal processors. The parallel cascade model structure shown in FIG. 1A was used to generate the results shown in this patent application. However, more elaborate parallel cascade models can be used, for example where some or all of the cascades involve further alternating dynamic linear and static nonlinear elements. Also, while the system identification technique below uses PCI in some embodiments, other embodiments of the invention may use other system identification techniques including, as non-limiting examples, fast orthogonal search, orthogonal search method, a method of searching through a set of candidate terms, least angle regression, Volterra kernel identification, and artificial neural networks.

Further Detail about System Identification

To find a PCI model, trial values of certain parameters are typically set, such as memory length for the dynamic linear element beginning a cascade, the degree of the polynomial that follows (if the static nonlinearity is assumed to be a polynomial), the maximum number of cascades allowed in the model, a threshold concerning the reduction in MSE before a given candidate cascade can be allowed into the model, and the number of candidate cascades tested. These parameters will depend on the system input and desired system output, which in turn depend on the IMU signals to be improved, and the desired signals for improving navigation. One way of finding good parameter settings is by testing the resulting capability of identified models, for various trial parameter values, to predict the desired system output over data not used to find the models.

A form of Deep Learning can also be used with Parallel Cascade Identification (PCI) and fast orthogonal search (FOS). For example, we can apply particle filtering to many alternative FOS and/or PCI models. This especially suited to PCI, since this algorithm has a built-in random element in the formation of candidate cascades that are tested, producing many possible models for the same training data. The approach is to use only some of the input/output training data to find many possible FOS and/or PCI models. For example, different FOS models will result depending on the searched candidate functions, which correspond to different assumed maximum delays in the input and output, or degree of cross-product terms. Similarly, if the PCI model comprises a sum of cascades, each of which comprises a dynamic linear element followed by a static nonlinear polynomial, then each of the dynamic linear elements may be defined using a randomly-selected slice of a first- or higher-order crosscorrelation of the input with the current residual, with weighted discrete delta functions added or subtracted at diagonal values. Also, different assumed memory lengths for the dynamic linear elements, and polynomial degree for the static nonlinearities, and maximum number of cascades in a model, and threshold for accepting a cascade, can result in many possible models.

Suppose, for example, that there are 1000 such models. Then further training input values are passed into each of the models, and the resulting model outputs are compared with the actual training output values. For a given model, the closer its output values are to the actual output values, the higher is the probability that the model is valid (and more important). The models are then selected by importance (importance sampling), whereby the greater the probability attached to the model the greater is the likelihood of selecting the model. One way of ensuring this is to increase the number of each model proportional to the probability of validity attached to the model, suppose 10,000 models result in total. Then randomly select a 1000 of these models.

Pass further training input values through each model, compare the resulting model output values with the corresponding actual training output values, and continue. In this way, the models become more and more likely to be effective models. Then, to predict the output corresponding to new input values, average the corresponding outputs of the models. We can keep adding some further models, each time assessing their ability to predict desired output values not used to find those models. This can also be done using mixture particle filtering. For example, we can add further models whose importance will be weighed by their ability to predict the most recent desired output values, plus models trained on more recent data. This helps to adjust to a changing relation between the system input and the desired system output.

In this procedure, the PCI and/or the FOS models are the “particles”, with their importance determined by their individual abilities to predict the desired output over data not used to find the models. This procedure makes it easy to combine many types of models, and advantageous to create models for many different trial parameter settings without a priori knowledge of effective values.

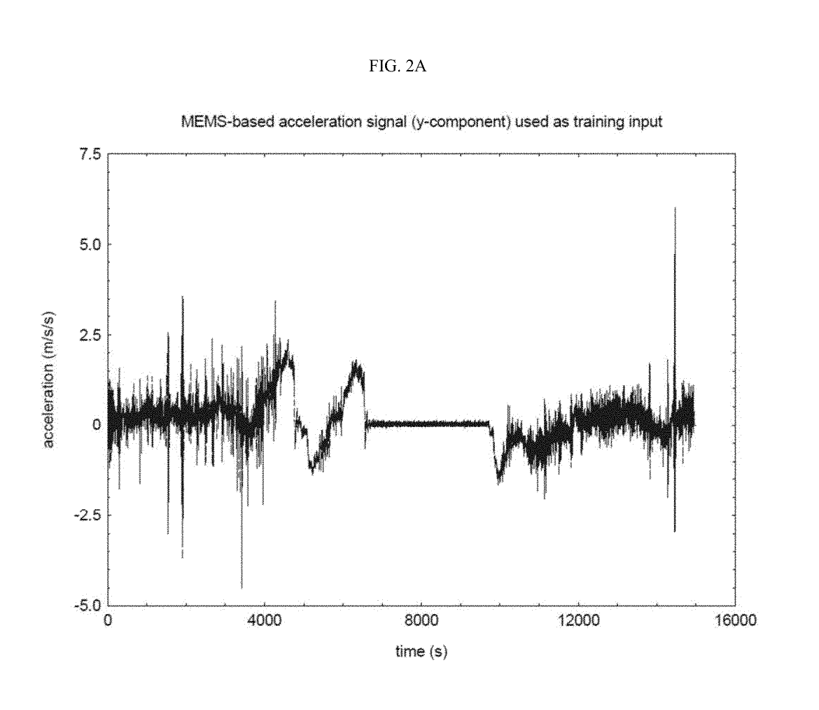

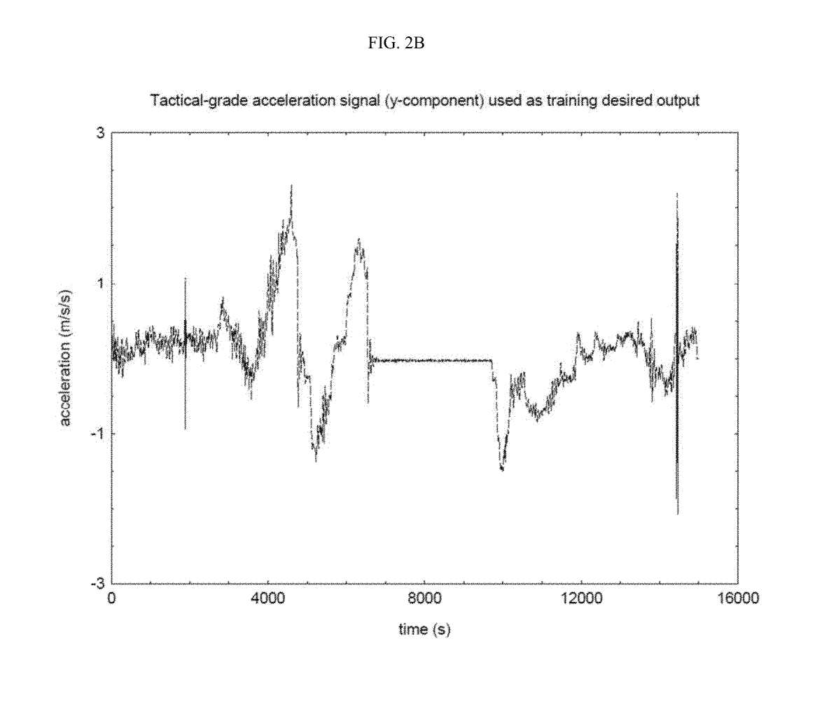

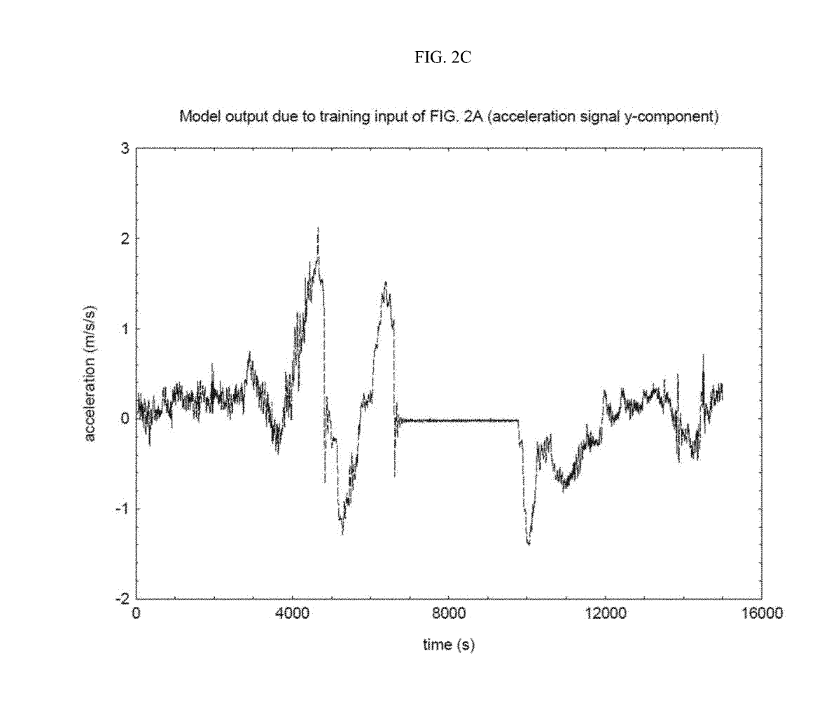

FIG. 2A illustrates a portion of a MEMS-based acceleration signal (y-component, sometimes called the forward accelerometer signal), from Crossbow MEMS grade IMU (Crossbow Technologies, San Jose, Calif., USA). The first 15,000 points shown of the signal, which is obviously very noisy, were used as the training input, in illustrating one embodiment of the claimed invention. The data in FIG. 2A and all of the data below were obtained with a sampling rate of 100 Hz (i.e. 100 samples/sec).

The first 15,000 points of the signal shown in FIG. 2B illustrate a corresponding training desired output signal for the acceleration y-component, from a HG-1700 tactical grade IMU (Honeywell), which is more expensive and produces a more accurate navigation solution than the Crossbow MEMS grade IMU. This desired output signal has much less noise than the input signal of FIG. 2A. Although a tactical grade signal was used here to form a desired output signal, other embodiments may use other ways to form a desired output signal, e.g. a navigation-grade IMU may be used. In addition, as discussed below, it is not necessary to have a more accurate IMU, than used to form the training input, available to form the training desired output.

The signals of FIGS. 2A,B are used to illustrate the training input/output data employed to identify a parallel cascade model for improving the MEMS-based acceleration y-component signal in an embodiment of the claimed invention. Although 15,000 input/output pairs are used here, other embodiments may use a fewer or greater number of pairs for training. The PCI method described in Korenberg, 1991 (cited above) was used to identify a parallel cascade model. When this model was fed the input signal of FIG. 2A, the resulting model output signal (FIG. 2C) closely approximated the desired output of FIG. 2B: the Mean Square Error (MSE) was about 4.62% when expressed relative to the variance of the desired output signal. Compared to the desired output signal of FIG. 2B, the MSE of the model output signal (FIG. 2C) of about 4.62% is much less than the MSE of the MEMS signal (FIG. 2A) of about 34.22%, when both MSE values are expressed relative to the variance of the desired output signal of FIG. 2B.

However, a key issue is how well does the identified model maintain its accuracy over novel input data, i.e. novel MEMS input signals not used to find the model. The following figures illustrate that the identified model maintained its accuracy over novel input data.

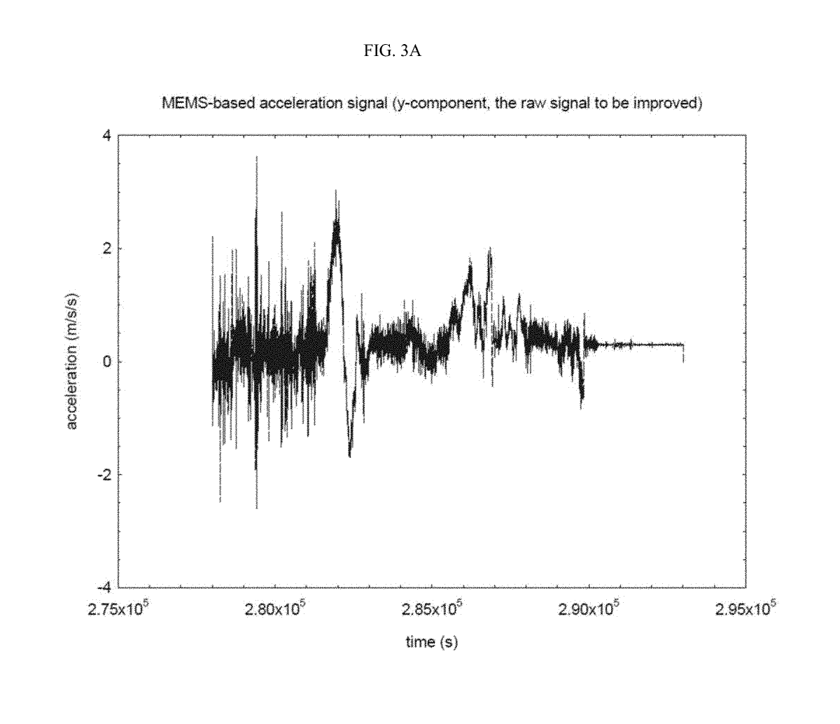

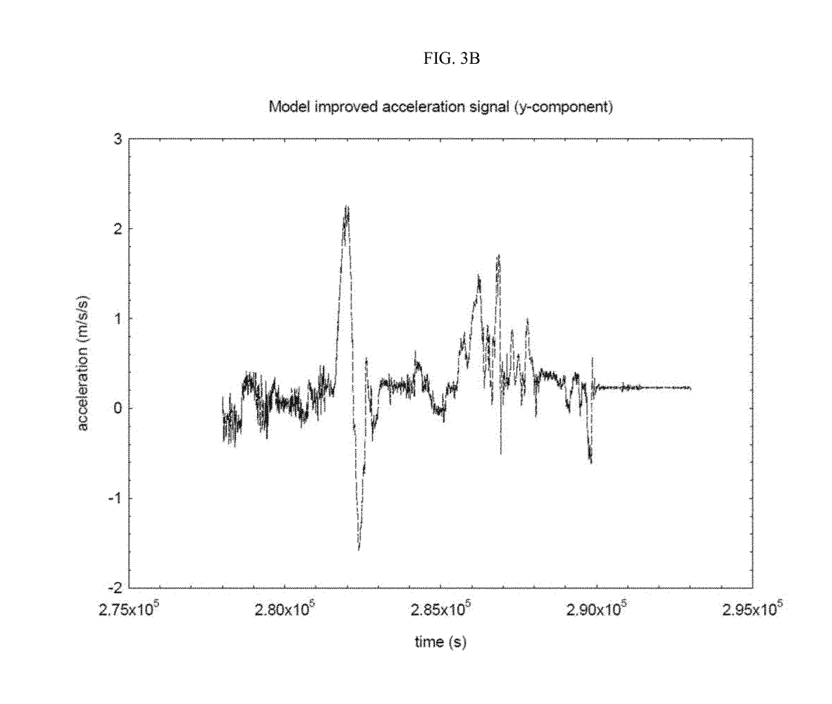

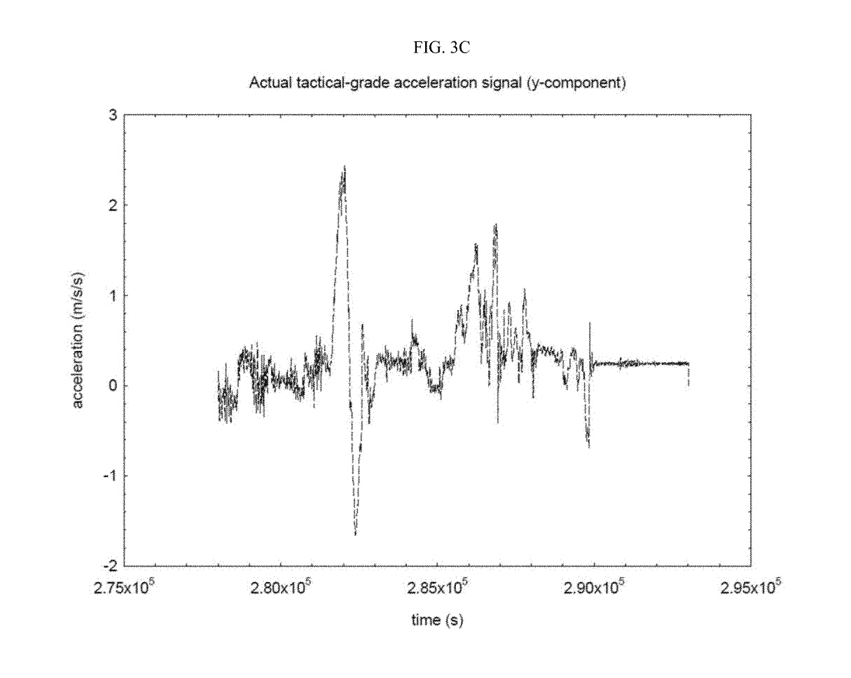

For example, FIG. 3A shows a portion of a MEMS-based acceleration signal (y-component), recorded starting about 43 minutes after the end of the training data illustrated in FIGS. 2A,B that were used to find the parallel cascade model. FIG. 3B shows the result of feeding the MEMS signal of FIG. 3A through the model in order to convert it into a signal that closely approximates the signal from the more expensive tactical-grade IMU (FIG. 3C). Compared to the desired signal of FIG. 3C, the MSE of the model-improved signal (FIG. 3B) is about 1.6%, in contrast the MSE of the MEMS signal (FIG. 3A) is about 26.5%, when both MSE values are expressed relative to the variance of the desired signal of FIG. 3C.

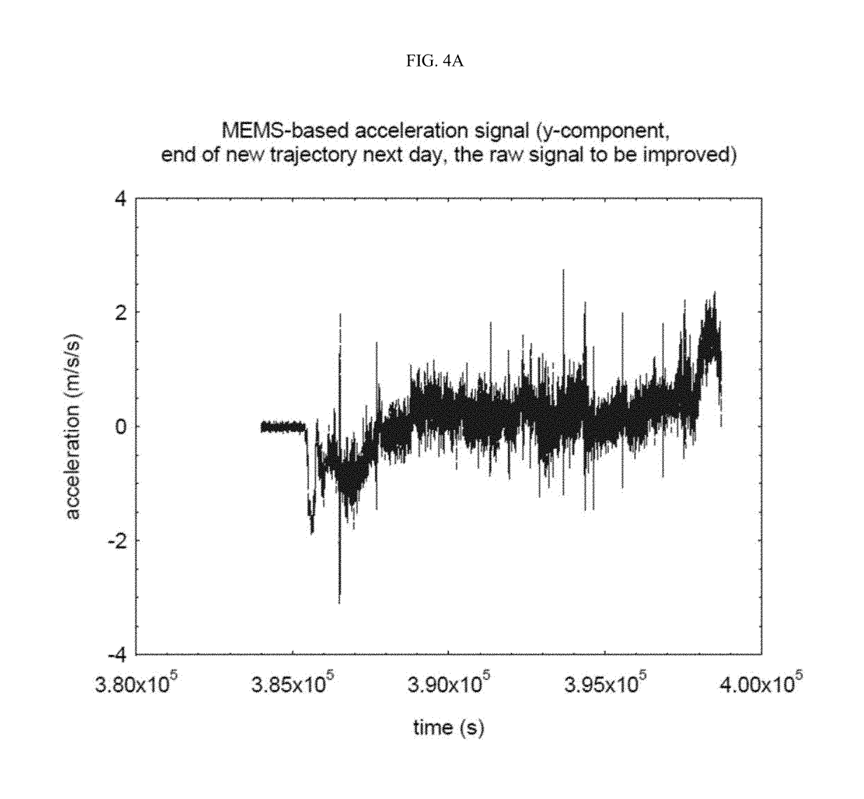

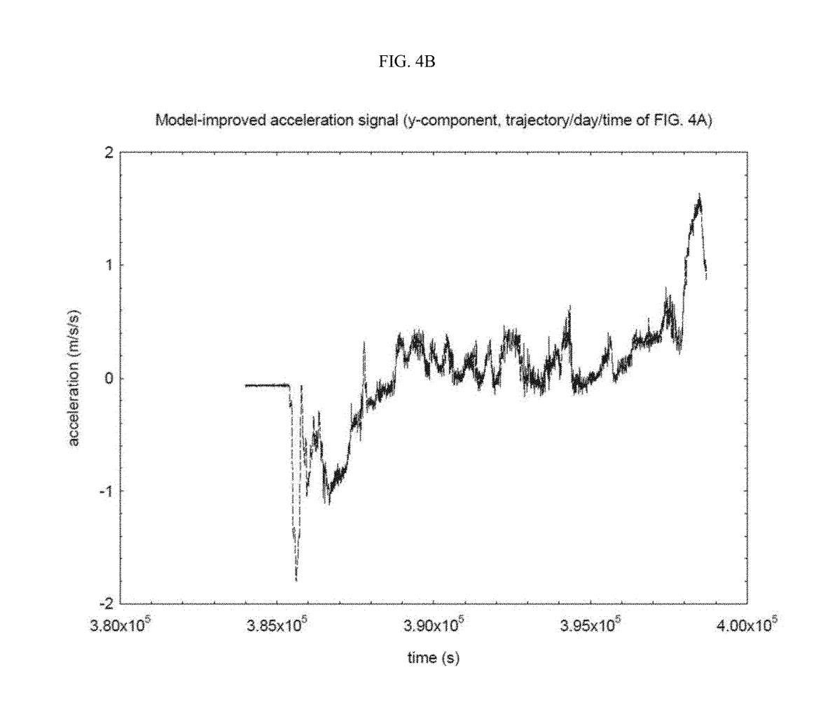

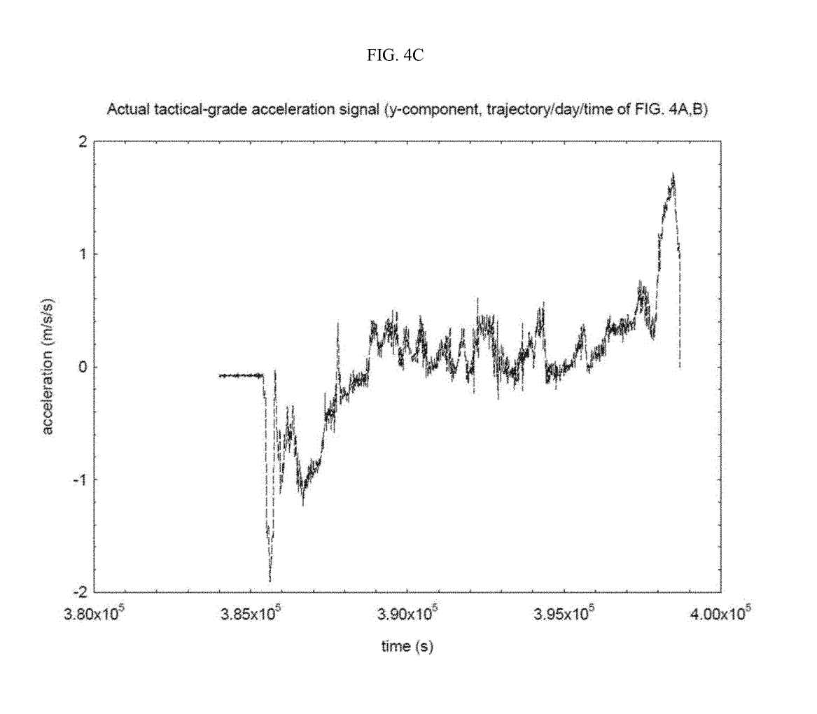

Similarly, FIG. 4A illustrates a portion of a MEMS-based acceleration signal (y-component), recorded near the end of a different trajectory one day after the gathering of the training data in FIGS. 2A,B that had been used to find the model. FIG. 4B shows the result of feeding the MEMS signal of FIG. 4A through the model in order to convert it into a signal that closely approximates the signal from the more expensive tactical-grade IMU (shown in FIG. 4C). Compared to the desired signal of FIG. 4C, the MSE of the model-improved signal (FIG. 4B) is about 0.733%, in contrast to the MSE of the MEMS signal (FIG. 4A) of about 25.56%, when both MSE values are expressed relative to the variance of the desired signal of FIG. 4C. This illustrates remarkable sustained reliability of the identified model, since it has been thought that MEMS-based devices change their noise characteristics every time they are switched on. However, in this test, switching on the MEMS-based device the next day and using it on a new trajectory certainly did not make the previously identified model obsolete. Rather the model held up very well (MSE=0.733%) though it had been obtained with different data from the previous day. This shows that it was possible to take the output from a cheap MEMS-based sensor, process it rapidly and convert it to very nearly the output of a much more expensive (and larger) instrument, and the model used to improve the MEMS signal remained good from one day/trajectory to the next.

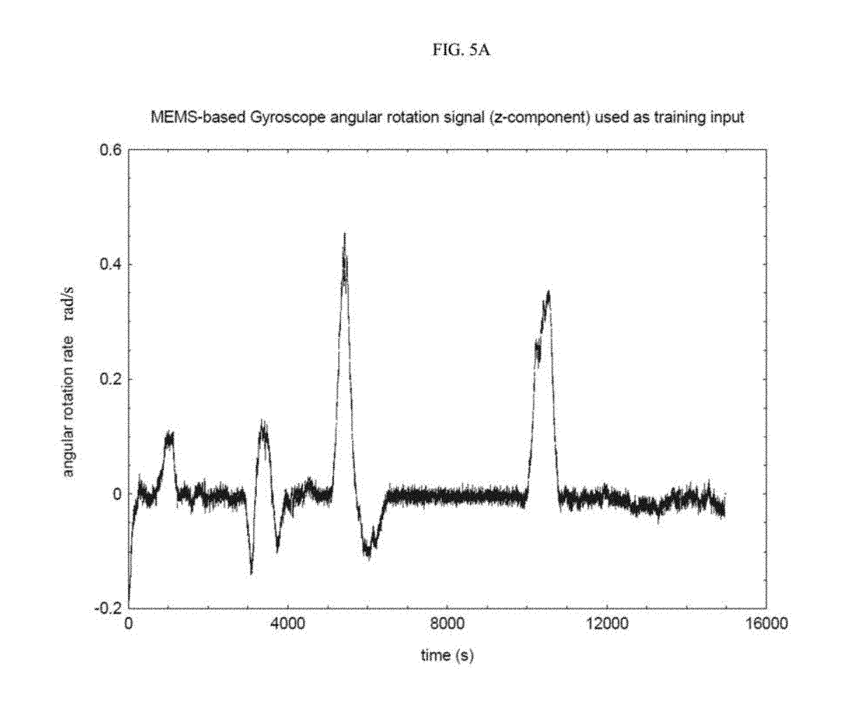

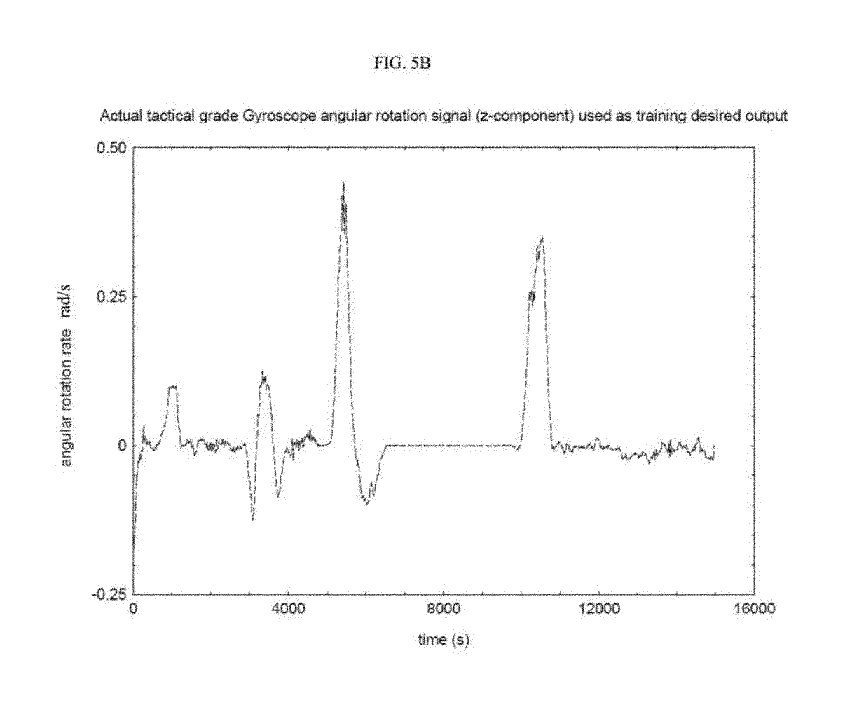

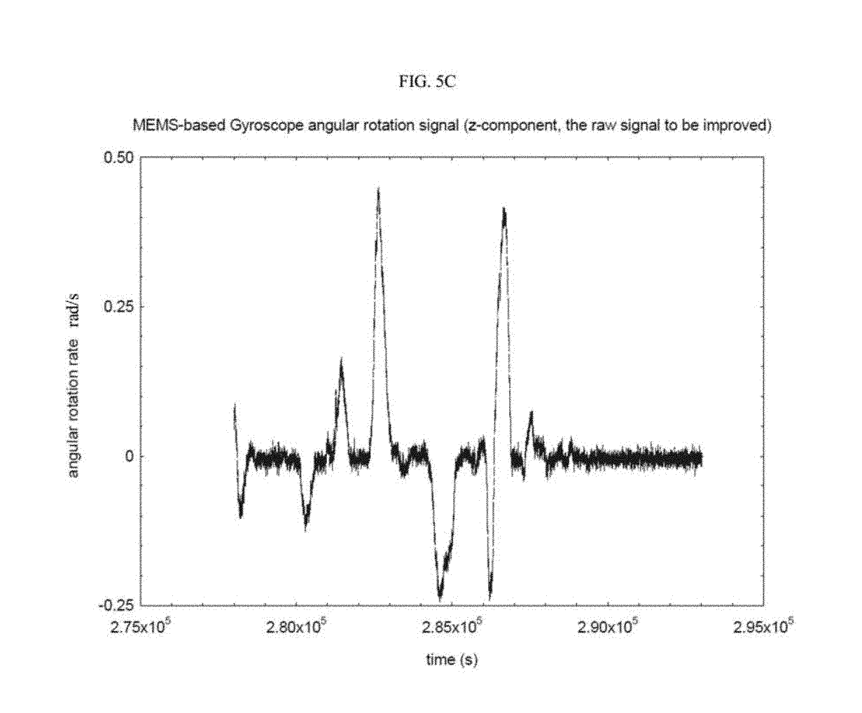

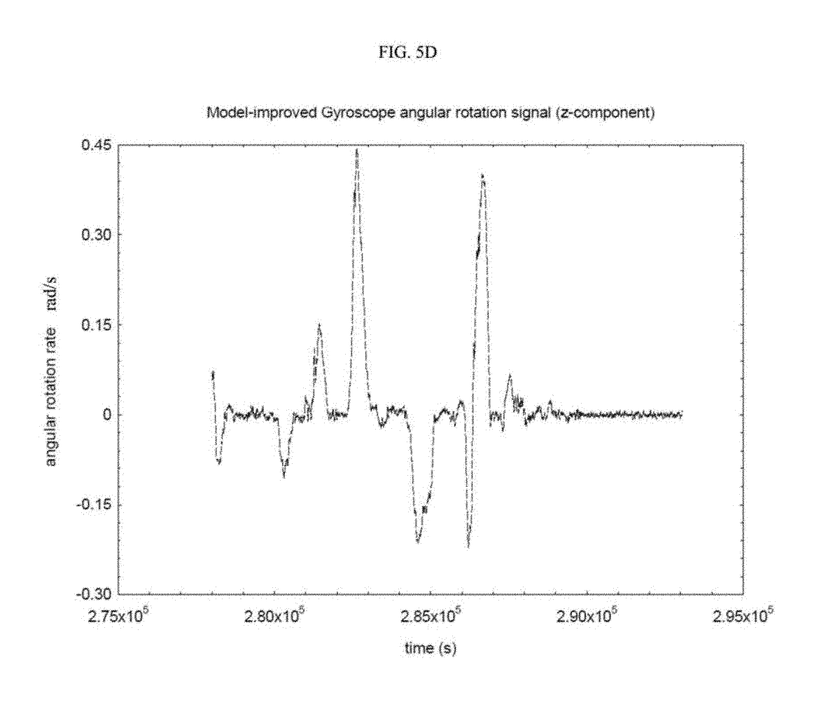

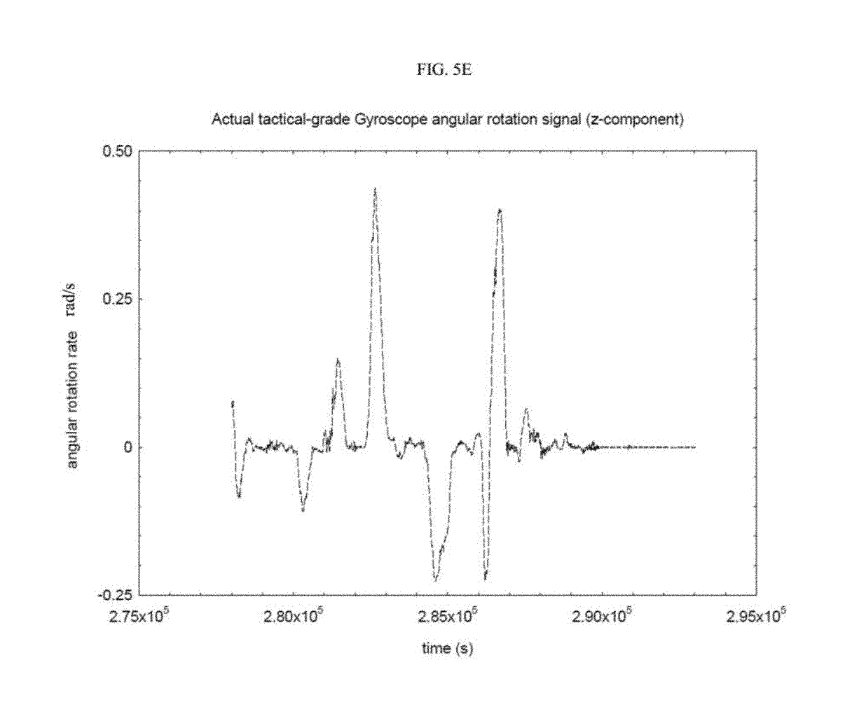

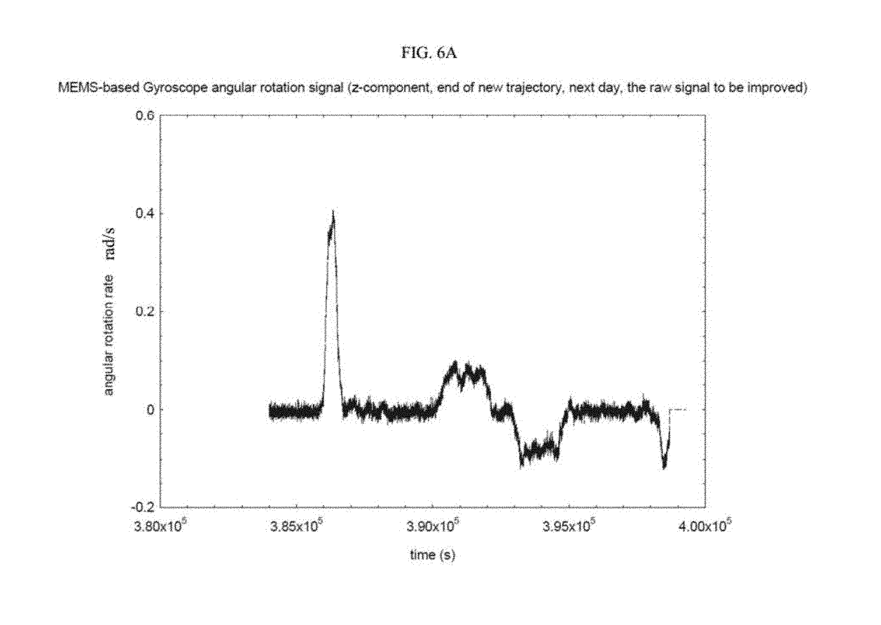

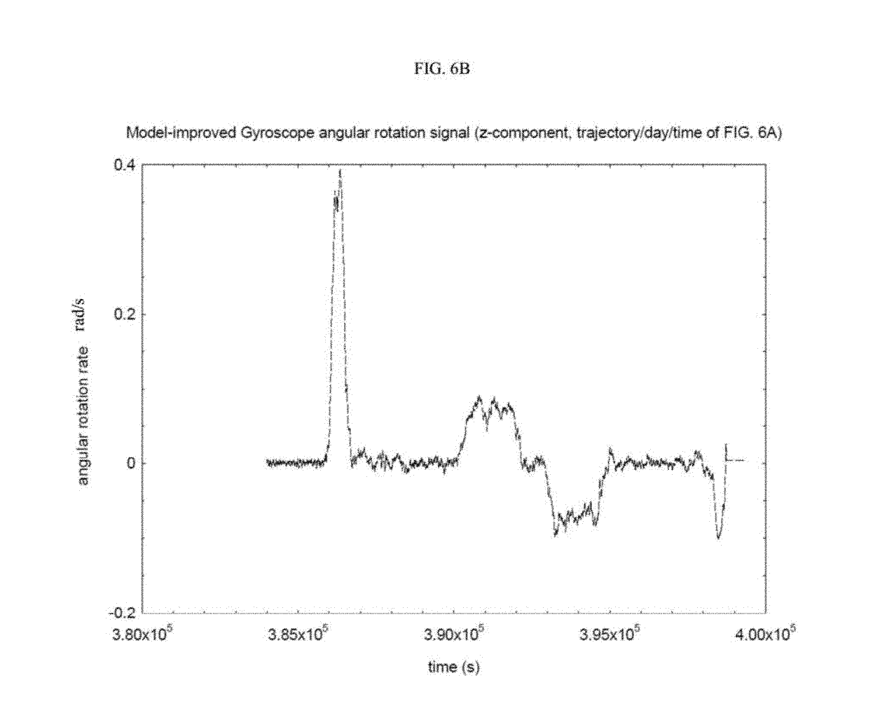

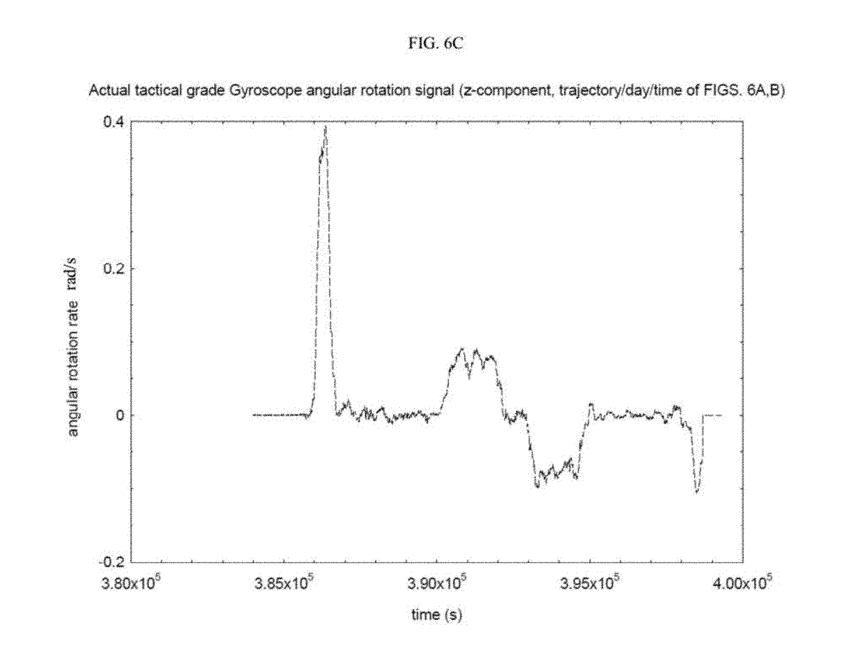

FIGS. 5 and 6 relate to gyroscope angular rotation signals, and methods of improving the accuracy thereof.

FIG. 5A illustrates a portion of a MEMS-based gyroscope signal (z-component, sometimes called the vertical gyroscope signal), from Crossbow MEMS grade IMU (Crossbow Technologies, San Jose, Calif., USA). The first 15,000 points shown of the signal, which is obviously noisy, were used as the training input, in illustrating one embodiment of the claimed invention.

The first 15,000 points of the signal shown in FIG. 5B illustrate a corresponding training desired output signal for the gyroscope z-component, from a HG-1700 tactical grade IMU (Honeywell), which is more expensive and produces a more accurate navigation solution than the Crossbow MEMS grade IMU. This desired output signal has less noise than the input signal of FIG. 5A. Although a tactical grade signal was used here to form the desired output signal, other embodiments may use other ways to form a desired output signal, e.g. a navigation-grade IMU may be used. In addition, as discussed below, it is not necessary to have a more accurate IMU, than used to form the training input, available to form the training desired output.

The signals of FIGS. 5A,B are used to illustrate the training input/output data employed to identify a parallel cascade model for improving the MEMS-based gyroscope z-component signal, in an embodiment of the claimed invention. These training data were gathered at the same time as the training data in FIGS. 2A,B. Although 15,000 input/output pairs are used here, other embodiments may use a fewer or greater number of pairs for training. The PCI method described in Korenberg, 1991 (cited above) identified a parallel cascade model that, when fed the input signal of FIG. 5A, produced a model output signal that closely approximated the desired output of FIG. 5B: the Mean Square Error (MSE) was about 0.724% when expressed relative to the variance of the desired output signal.

Again, a key issue is how well does the identified model maintain its accuracy over novel input data, i.e. novel MEMS input signals not used to find the model. The following figures illustrate that the identified model for improving the MEMS gyroscope z-component signal maintained its accuracy over novel input data.

For example, FIG. 5C shows a portion of a MEMS-based angular rotation signal (z-component), recorded starting about 43 minutes after the end of the training data illustrated in FIGS. 5A,B that were used to find the parallel cascade model. FIG. 5D shows the result of feeding the MEMS signal of FIG. 5C through the model in order to convert it into a signal that closely approximates the signal from the more expensive tactical-grade IMU (FIG. 5E). Compared to the desired signal of FIG. 5E, the MSE of the model-improved signal (FIG. 5D) is about 0.728%, in contrast the MSE of the MEMS signal (FIG. 5C) is about 1.356%, when both MSE values are expressed relative to the variance of the desired signal of FIG. 5E.

Similarly, FIG. 6A illustrates a portion of a MEMS-based angular rotation signal (z-component), recorded near the end of a different trajectory one day after the gathering of the training data in FIGS. 5A,B that had been used to find the model. FIG. 6B shows the result of feeding the MEMS signal of FIG. 6A through the model in order to convert it into a signal that closely approximates the signal from the more expensive tactical-grade IMU (FIG. 6C). Compared to the desired signal of FIG. 6C, the MSE of the model-improved signal (FIG. 6B) is about 0.355%, in contrast to the MSE of the MEMS signal (FIG. 6A) of about 1.335%, when both MSE values are expressed relative to the variance of the desired signal of FIG. 6C. Again, this illustrates remarkable sustained reliability of the identified model, since the model held up very well (MSE=0.355%) though it had been obtained with different data from the previous day. This shows that it was possible to take the output from a cheap MEMS-based sensor (a lower-end IMU), process it rapidly and convert it to very nearly the output of a much more expensive instrument (a higher-end IMU), and the model used to improve the MEMS signal remained good from one day/trajectory to the next. This is a stand-alone model that does not need GPS to be effective. In one embodiment of the invention, a method has been disclosed for developing a stand-alone model to improve a navigation solution resulting from a lower-end IMU, comprising (a) using a signal from the moving lower-end IMU to define a first signal, (b) using a signal from a more accurate source, corresponding to the moving lower-end IMU, to define a second signal, and (c) using the first and the second signals to develop the model to transform a signal from the lower-end IMU into a signal resulting in an improved navigation solution.

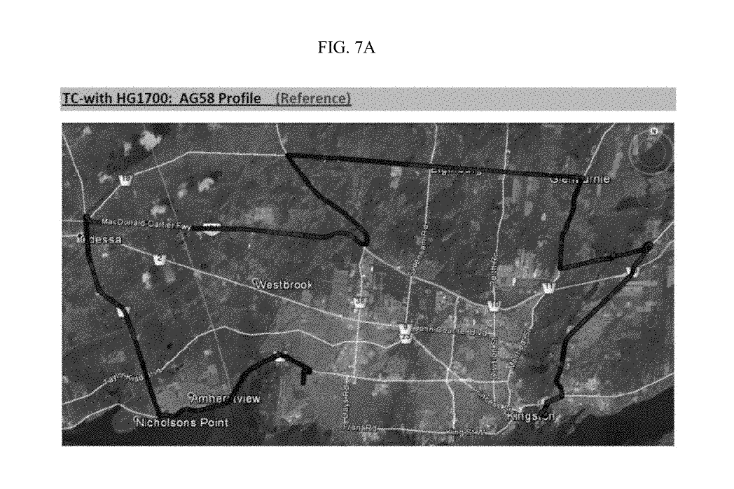

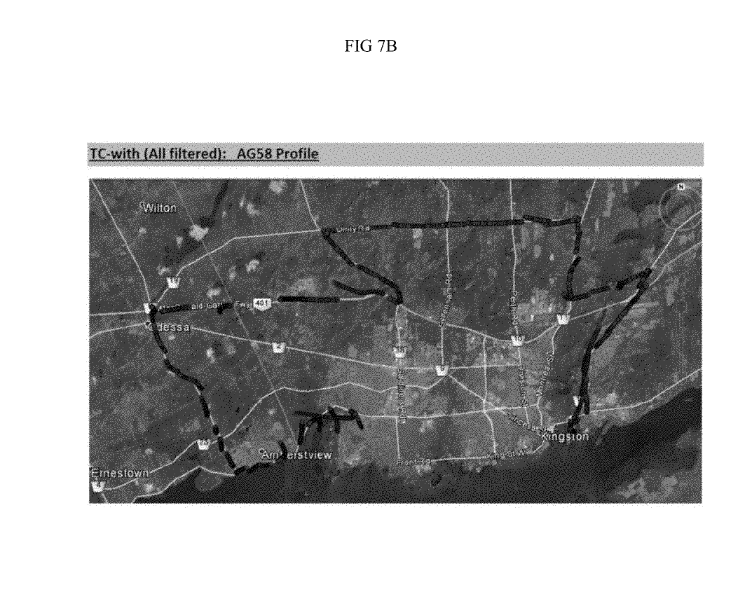

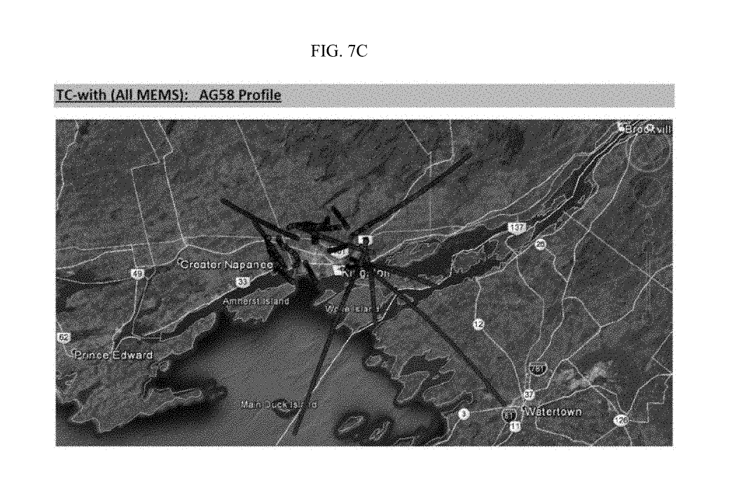

FIGS. 7A,B,C relate to extended testing of an embodiment of the claimed invention. First, a separate model (filter) was found for each of the MEMS (Crossbow) gyroscope and accelerometer x-, y-, z-components, six models in total, using 15,000 points of training data gathered at the same time and trajectory as the training data in FIGS. 2A, 5A. Then the obtained models were tested on the different trajectory taken the next day, corresponding to FIGS. 4A, 6A but this time over 390,078 points (more than 1 hour). FIG. 7A shows the extended trajectory, as indicated by a high-end tactical grade IMU (HG1700) tightly-coupled with GPS integration. The FIG. 7A trajectory is the reference with which trajectories in FIGS. 7B (model-improved MEMS) and 7C (raw MEMS) should be compared.

FIG. 7B shows the corresponding trajectory as indicated when the tactical grade IMU signals are replaced by the model-improved MEMS accelerometer and gyroscope signals, again tightly-coupled with GPS integration. The FIG. 7B trajectory corresponds well with that of FIG. 7A.

FIG. 7C shows the corresponding trajectory as indicated when the tactical grade IMU signals are replaced by the raw (i.e. not model-improved) MEMS signals, again tightly coupled with GPS integration. There is little similarity between the FIG. 7C and FIG. 7A trajectories. The effect of the models of the claimed invention is to reduce the root-mean square (RMS) horizontal error for the FIG. 7B trajectory to less than 1/73 (about 1.4%) of that for the FIG. 7C trajectory.

Although signals from the tactical-grade IMU were used here to illustrate the desired output signals for training the model, it is not necessary to have such a more expensive IMU available. For example, certain methods such as FOS and wavelet de-noising have been shown to improve, for navigation purposes, MEMS-based and tactical-grade-based signals. See, e.g., A. Noureldin, J. Armstrong, A. El-Shafie, T. Karamat, D. McGaughey, M. Korenberg, and A. Hussain, 2012, “Accuracy Enhancement of Inertial Sensors Utilizing High Resolution Spectral Analysis”, Sensors, Vol. 12, pp. 11638-11660; doi:10.3390/s120811638. In this Sensors article, spectral FOS processing of MEMS-based signals was able to improve vehicle horizontal positioning by about 24% averaged over 9 GPS outages, with the best improvement over an outage exceeding 74%. The original MEMS-based signal can be used to define the training input signal, while the corresponding spectral FOS-improved signal can be used to define the training desired output signal, then the model for improving the MEMS-based signals can be identified from these training data.

There are further ways that training desired output signals can be formed without access to expensive IMU devices. As a non-limiting example, when a global navigation satellite systems (GNSS) receiver, for example a Global Positioning System (GPS) receiver, is available, it can be used to obtain velocity in x, y, and z directions. Then these velocity signals can be differentiated to obtain corresponding acceleration signals and thus form training desired output signals. For example, spectral FOS can be used to obtain noise-reduced sinusoidal or exponentially-decaying sinusoidal series models of the velocity signals, which can then be differentiated noiselessly to obtain estimates of the corresponding desired acceleration signals. These desired output signals can then be used in finding models, and updating models on-route, to improve MEMS-based acceleration signals. Similarly, with detailed positioning information available from the GPS signals, one can calculate estimates of angular rotation rates to form training desired output signals. These desired output signals can then be used in finding models, and updating models on-route, to improve MEMS-based gyroscope angular rotation signals. Alternatively, an on-board odometer can be used to measure velocity in the forward direction (y-component) which can then be differentiated to update the desired y-acceleration signal. As another non-limiting example for producing desired output signals for training purposes, start with the signals from the low-cost IMU, then make small changes in them, each time keeping only those changes that result in improved navigation. Particle filtering with 1000s of threads can be used to converge to signals from a more accurate but fictitious instrument that cause an improved navigation solution.

When the tactical-grade IMU is available, then a model can be identified to improve MEMS-based signals even beyond the tactical-grade accuracy. The same Sensors, 2012 article cited above showed that spectral FOS could decrease tactical-grade mean horizontal position errors by up to 43%. Hence the MEMS-based signal can again be used to define the training input signal, while the corresponding spectral FOS-improvement of the tactical-grade signal can be used to define the training desired output signal, then the model for improving the MEMS-based signals can be identified from these training data. The resulting model can then improve MEMS-based signals even beyond the tactical-grade accuracy. Also, the original tactical-grade signal can be used to define the training input signal, while the corresponding spectral FOS-improvement of the tactical-grade signal can be used to define the training desired output signal, then the model for improving the tactical-grade signals can be identified from these training data. In this case the model can improve the tactical-grade signal to be closer to navigation-grade accuracy.

Although the above examples have illustrated how models can be found to improve acceleration y-component and gyroscope z-component signals, these are non-limiting examples, and other models can be obtained to improve all of the component signals from the accelerometer and the gyroscope, as well as magnetometer and barometric signals, and any other signals used for navigation.

Although the models illustrated above for improving the output of IMUs have been of the single-input single-output form, other embodiments can use multi-variate model forms, e.g. multi-input single-output and multi-input multi-output model forms. For example, the six training inputs can be the MEMS-based x-, y-, and z-components from both the accelerometer and the gyroscope, and the corresponding six training desired outputs can be the navigation-grade x-, y-, and z-components from both the accelerometer and the gyroscope. Then a six-input, six-output PCI model can be found with the method described in Korenberg, 1991 (cited above). Alternatively, a six-input, six-output Volterra series model can be identified using, e.g., the fast orthogonal algorithm (M. Korenberg, 1988, “Identifying Nonlinear Difference Equation and Functional Expansion Representations: The Fast Orthogonal Algorithm”, Annals of Biomedical Engineering, Vol. 16, pp. 123-142), or a multi-input multi-output artificial neural network can be found, or other multi-input multi-output system identification techniques can be employed to find the model. The resulting six-input six-output model can then be used to improve simultaneously novel MEMS-based accelerometer and gyroscope x-, y-, and z-component signals. It will sometimes be possible to locate models for improving the navigation solution on the processor of the lower-end IMU.

The same methods disclosed in the claimed invention can be used to build models that can compensate for short-term and long-term drifts in MEMS-based gyroscopes and accelerometers induced by temperature variations. For example, different models can be constructed for different temperature ranges, and then can be automatically employed to compensate for temperature variations.

Having thus described several embodiments of the claimed invention, it will be rather apparent to those skilled in the art that the foregoing detailed disclosure is intended to be presented by way of example only, and is not limiting. Many advantages for method and system for improving inertial measurement unit sensor signals have been discussed herein. Various alterations, improvements, and modifications will occur and are intended to those skilled in the art, though not expressly stated herein. These alterations, improvements, and modifications are intended to be suggested hereby, and are within the spirit and the scope of the claimed invention. Additionally, the recited order of the processing elements or sequences, or the use of numbers, letters, or other designations therefore, is not intended to limit the claimed processes to any order except as may be specified in the claims. Accordingly, the claimed invention is limited only by the following claims and equivalents thereto.

1. A method of constructing a model on a computer processor for improving inertial measurement unit (IMU) data, comprising the steps of
a) using the IMU data to define an input signal;
b) using a source of navigation data more accurate than the IMU data to define a desired output signal corresponding to the input signal such that using the desired output signal results in more accurate navigation, wherein the desired output signal is not substantially equal to a shifted version of the input signal; and
c) developing the model to approximately convert the input signal into the desired output signal.

2. The method of claim 1, wherein the IMU comprises at least one of a microelectromechanical system (MEMS), a tactical-grade IMU, and a navigation-grade IMU.

3. The method of claim 1, wherein the step of developing the model includes the use of a system identification technique.

4. The method of claim 3, wherein the system identification technique includes at least one of parallel cascade identification, fast orthogonal search, a method of searching through a set of candidate terms, least angle regression, Volterra kernel identification, and artificial neural networks including networks developed using deep learning.

5. A method of improving inertial measurement unit (IMU) data from a sensor assembly for navigation, comprising the steps of
a) using the IMU data to define an input signal; and
b) feeding the input signal into a processor programmed to use a model that is capable of producing a more accurate signal for a navigation solution, wherein the model is not simply a one-ahead predictor model of stochastic error in the sensor assembly, and wherein the model does not require updates from global navigation satellite systems (GNSS) to produce the more accurate signal during navigation, the model further comprising at least one of:
(i) a cascade structure including a series connection of a dynamic linear element and a static nonlinear element;
(ii) a Volterra series; and
(iii) an artificial neural network including a network developed using deep learning.

6. The method of claim 5, wherein the input signal is simultaneously fed into a plurality of the cascade structures, and wherein a model output is obtained by a linear combination of outputs from the cascade structures.

7. The method of claim 1, wherein a global navigation satellite systems (GNSS) receiver is used in defining the desired output signal.

8. The method of claim 7, wherein the GNSS receiver is a global positioning system (GPS) receiver.

9. A navigation module for use with a moving platform, the module including a sensor assembly capable of obtaining readings relating to navigational information and producing a sensor assembly signal indicative thereof, at least one processor coupled to the sensor assembly to receive the sensor assembly signal and containing a model for processing the sensor assembly signal to produce a more accurate signal for a navigation solution, wherein the model is not simply a one-ahead predictor model of stochastic error in the sensor assembly, wherein using the more accurate signal results in a more accurate navigation solution, and wherein the model does not require updates from Global Navigation Satellite Systems (GNSS) to produce the more accurate signal during navigation.

10. The navigation module in claim 9, wherein the sensor assembly comprises at least one accelerometer and one gyroscope.

11. The use of the module in claim 9, wherein the moving platform is a vehicle.

12. The use of the module in claim 9, wherein the moving platform is an unmanned aerial vehicle.

13. The navigation module in claim 9, further comprising
(i) a receiver for receiving absolute navigational information from an external source; and
(ii) model-building and updating means coupled to the receiver, the sensor assembly, and the at least one processor, and operative to create and update the model for processing the sensor assembly signal to produce an improved signal relating to navigation information.

14. The navigation module in claim 13, wherein the receiver for receiving absolute navigational information is a GNSS receiver.

15. The navigation module in claim 14, wherein the GNSS receiver is a Global Positioning System (GPS) receiver.

16. The navigational module in claim 13, wherein the sensor assembly comprises at least one accelerometer and one gyroscope.

17. The navigational module in claim 13, wherein the model-building and updating includes:
(i) using data from the sensor assembly in defining an input signal;
(ii) using data from the receiver in defining a desired output signal corresponding to the input signal; and
(iii) developing the model to approximately convert the input signal into the desired output signal.

18. The navigational module in claim 13, further comprising means for obtaining speed information and producing an output indicative thereof, wherein the model-building and updating means is further coupled to the means for obtaining speed information, and operative to use the speed information to update the model.

19. The navigational module in claim 18, wherein the means for obtaining speed information is an odometer.

20. A method of increasing the predictive ability over novel data of models on a computer processor for improving navigation data, including the steps of:
(i) using training values of system input/desired system output data to obtain a plurality of models corresponding to different parameter settings;
(ii) measuring the ability of the obtained models to predict desired output values not used to obtain the models;
(iii) choosing a subset of the models by preferentially selecting according to measured predictive ability; and
(iv) averaging the outputs of the selected models over the novel data.

21. The method of claim 20 comprising improving the predictive ability of FOS, PCI, Volterra series, or artificial neural network models.
